(19) United States
(12) Patent Application Publication
(10) Pub. No.: US 2008/0100632 A1
(43) Pub. Date: May 1, 2008

(54) Digital Photo Frame for Saving Power

(76) Inventor: Juen-Tien Peng, Chung Li (TW)

Correspondence Address: HDSL, 4331 STEVENS BATTLE LANE, FAIRFAX, VA, 22033, US

(21) Appl. No.: 11/554,740

(22) Filed: Oct. 31, 2006

(51) Int. Cl. G06T 1/60

(52) U.S. Cl. 345/530

(57) ABSTRACT

A digital photo frame includes: at least one storage device for storing a digital photo; a display device for displaying the digital photo; a light-sensing component disposed on the display device, and for detecting an intensity of environmental brightness and sending a signal; and a processing unit for processing the digital photo stored in the storage device and displaying the photo in the display device, and opening or closing a backlight module of the display device according to the signal from the light-sensing component. With this configure, the digital photo frame of the invention may save electric energy.

### BACKGROUND

The invention relates to a digital photo frame, which can open or close the light source of the digital photo frame according to an intensity of environmental brightness.

With the increasing development of the technologies, a digital camera has been becoming a substitute of a traditional camera progressively because of many advantages of the digital camera. For example, when the traditional camera works, a negative or film is needed, and the negative or film can only be used once without recycle. In contrast to the traditional camera, using the digital camera, you can get some electronic files, and the files can be stored and managed in a computer.

Since the digital camera is used world widely, people are watching a photo in a different manner than the past. Thus a digital photo frame is invented to meet the demand, with the digital photo frame, you can enjoy a photo without being developed.

Substantially, a digital photo frame is an apparatus displaying information and works with a power supply; the screen of the digital photo frame usually is a liquid crystal display panel (LCD). The liquid crystals in a liquid crystal display panel do not emit any light themselves. The liquid crystals have to be lit up by a light source so as to clearly and sharply display text and images. Thus, a backlight module for an LCD is generally needed. But in all component of the digital photo frame, the backlight module consumes rather much energy. So closing the power supply of the backlight module may decrease much energy consumption. Since the digital frame usually is arranged at a certain occasion and not portable, the digital frame is powered by a plug connecting with a public power system and not a battery, so the user need not care if the power supply is enough, once the digital frame is connected with the public power system, the screen of the digital frame can display the digital photos in 24 hours. But displaying the digital photos in 24 hours will consume much electric power, what's more, a user may not enjoy the digital photo all the time, so when no user is using the digital frame, closing the power supply may save electric power.

Thus, a new device which overcomes the above-mentioned disadvantages is desired.

### BRIEF SUMMARY

The invention is to provide a digital photo frame, which can save electric power. According to an aspect of the invention, a light-sensing technique is used, if the digital frame is in use, the digital frame may close the electric power automatically to save electric power.

The invention is to provide a digital photo frame, which can save electric power. According to an aspect of the invention, a light-sensing component is used to detect a change of a brightness density of the environment light to determine if the digital frame is in use, so as to close or open the screen of the electric power automatically power.

According to one embodiment of the invention, a digital photo frame includes: at least one storage device for storing a digital photo; a display device for displaying the digital photo; a light-sensing component disposed on the display device, and for detecting an intensity of environmental brightness and sending a signal; and a processing unit for processing the digital photo stored in the storage device and displaying the photo in the display device, and opening or closing a backlight module of the display device according to the signal from the light-sensing component. With this configure, the digital photo frame of the invention may save electric energy.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a diagram of a digital photo frame according to one embodiment of the present invention.

FIG. 2 illustrates a schematic view of the digital photo frame in FIG. 1, in which a light-sensing component is arranged on the digital photo frame.

### DETAILED DESCRIPTION

The invention provides a digital photo frame. The digital photo frame can detect an intensity of environmental brightness and determine if the digital photo frame is in use, if the digital photo frame is not in use, the digital photo frame automatically closes the light source so as to save energy.

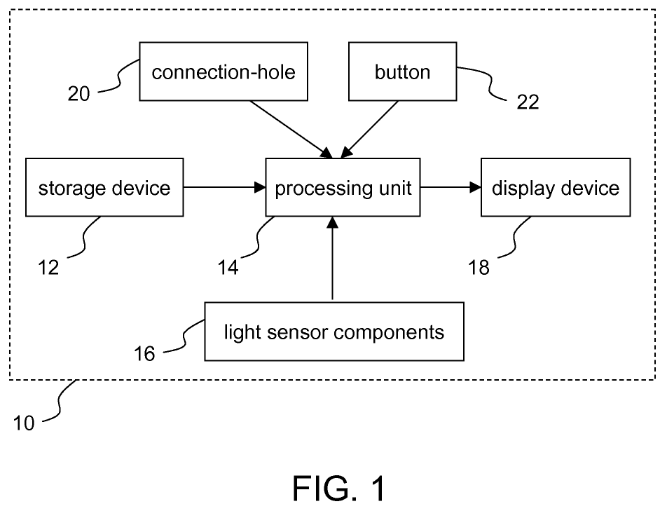

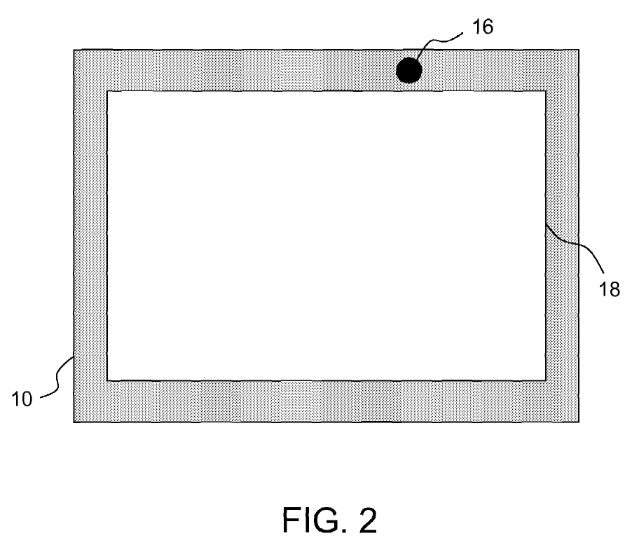

As shown in FIG. 1 and FIG. 2, a digital photo frame 10 according to one embodiment of the invention includes at least one storage device 12, a processing unit 14, a light-sensing component 16 and a display device 18. The display device 18 is usually a liquid crystal display. The storage device 12 is used for storing digital photos or images. The processing unit 14 can process digital photos and control the display device 18, so the processing unit 14 is used for processing the digital photos stored in the storage device 12 and making the images displayed on the display device 18. The light-sensing component 16 is disposed on the panel in the front of the display device 18. The light-sensing component 16 can detect the intensity environmental brightness and emit a corresponding signal into the processing unit 14. According to the signal coming from the light-sensing component 16, the processing unit 14 determines whether the digital photo frame 10 is in use or not, so as to open or close a backlight module of the display device 18 correspondingly. According to the invention, the digital photo frame 10 may include at least one connection-hole 20 for interconnecting with a digital camera or a memory card and reading digital information from them.

As the digital photo frame is usually arranged in a room, if the light in the room is closed, it usually means that no one in the room, or that someone rests in the room; if the light in the room is open, it usually means someone in the room and the digital photo frame may be in use. Hereby, through the light-sensing component 16, the digital photo frame according to the invention provides a switch function to a power-saving mode. When the light in the room is closed, the light-sensing component 16 can detect the intensity weakening of the brightness and emit a signal to the processing unit 14. Then the processing unit 14 sends a corresponding order to close the backlight module of the display device 18. When the light in the room is opened, the light-sensing component 16 can detect the intensity enhancing of the brightness and emit another signal to the processing unit 14. The processing unit 14 sends another corresponding order to open the backlight module of the display device 18.

Sometimes, a user may enjoy photos in a dark environment, and the digital photo frame may close the backlight of the display device 18 by mistake. For avoiding the mistake, a button 22 is arranged on the digital photo frame 10. The user may push down the button 22 to open the backlight module. When the digital photo frame 10 is in a power-saving state, if the user pushes down the button 22, a trigger signal is sent to the processing unit 14, then the processing unit 14 will open the backlight module of the display device 18 immediately. In contrast, when the light in the room is opened, if the user may push down the button 22, a trigger signal is sent to the processing unit 14, the processing unit 14 will determine that the user is enjoying the photos and will keep the backlight module of the display device 18 open even if the light in the room is closed. Of course, the switch of the backlight module of the display device 18 may be remote controlled through a remote device.

In summary, the invention provides a digital photo frame for saving energy. According to one embodiment of the invention, a light-sensing component is arranged on the panel in the front of the display device. The light-sensing component can detectan intensity's change of environmental brightness and determine whether the digital photo frame is or not in use, so as to open or close a backlight module of the display device. With this configure, the digital photo frame of the invention may save electric energy.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A digital photo frame comprising:
at least one storage device for storing a digital photo;
a display device for displaying the digital photo;
a light-sensing component disposed on the display device, and for detecting an intensity of environmental brightness and sending a signal; and
a processing unit for processing the digital photo stored in the storage device and displaying the photo on the display device, and opening or closing a backlight module of the display device according to the signal from the light-sensing component.

2. The digital photo frame according to claim 1, wherein the display device is a liquid crystal display device.

3. The digital photo frame according to claim 1, further comprising at least one button for controlling by a user to open or close the backlight module.

4. The digital photo frame according to claim 1, wherein, when the light-sensing component detects and determines the darkness of the environment, the backlight module will be closed.

5. The digital photo frame according to claim 1, wherein, when the light-sensing component detects the brightness of the environment, the backlight module will be opened.

6. The digital photo frame according to claim 1, further comprising at least one connection-hole for interconnecting a digital camera or a memory card.

7. The digital photo frame according to claim 1, wherein the backlight module may be open or closed through a remote device.
